(19) United States
(12) Patent Application Publication
(10) Pub. No.: US 2021/0164664 A1
(43) Pub. Date: Jun. 3, 2021

(54) METHOD FOR OPERATING A MIXING DEVICE AND MIXING DEVICE

(71) Applicant: GRUNDFOS HOLDING A/S, Bjerringbro (DK)

(72) Inventors: Thomas BLAD, Bjerringbro (DK); Christian BLAD, Bjerringbro (DK)

(21) Appl. No.: 16/635,702

(22) PCT Filed: Aug. 2, 2018
(86) PCT No.: PCT/EP2018/070970

§ 371 Date: Feb. 23, 2021

(30) Foreign Application Priority Data
Aug. 3, 2017 (EP) 17184778.3

(51) Int. Cl. F24D 19/10; F24D 3/10

(52) U.S. Cl. CPC F24D 19/1012; F24D 3/1066; F24D 2220/042; F24D 2220/0228; F24D 2220/0207

(57) ABSTRACT

The invention relates to a method for the operation of a mixing device in a heating facility, in which mixing device two heating medium flows of different temperatures are mixed for adjusting the temperature of the heating medium, wherein the mixing device comprises at least one circulation pump assembly (24; 46) which delivers the heating medium, wherein the at least one circulation pump assembly (24; 46) is regulated in its speed in dependence on a temperature value which is detected in the heating medium, as well as to a mixing device for mixing the heating medium flows.

### CROSS REFERENCE TO RELATED APPLICATIONS

This application is a United States National Phase Application of International Application, PCT/EP2018/070970, filed Aug. 2, 2018, and claims the benefit of priority under 35 U.S.C. § 119 of European Application 17 184 778.3, filed Aug. 3, 2017, the entire contents of which are incorporated herein by reference.

### TECHNICAL FIELD

The invention relates to a method for operating a mixing device in a heating facility as well as to a mixing device.

### TECHNICAL BACKGROUND

Mixers or mixing devices are often used in heating facilities, in order to be able to adjust and in particular reduce the temperature of a heating medium. In particular, this is necessary for floor heating systems which are operated at a lower feed temperature than that which is provided by a heating boiler. In such a mixing device, heated heating medium, in particular water, is mixed with cold heating medium from the return, for adjusting the temperature. As a rule, mixing valves which are thermostatically or electromotorically driven are applied for this, in order to change the mixing ratio for adapting the temperature.

Moreover, as a rule, several circulation pump assemblies are necessary in heating facilities, in order to deliver the heating medium or the heat transfer medium through the heating circuits.

### SUMMARY

It is an object of the invention to optimize the operation of such a heating facility to the extent that a greater energy efficiency can be achieved with a simple construction of the heating facility.

The method according to the invention serves for the operation of a mixing device in a heating facility, wherein a heating facility in the context of the present invention is basically to be understood as a facility for the temperature adjustment of a room or of a facility, irrespective of whether it serves for heating or cooling. I.e. a heating facility in the context of this invention is also to be understood as an air-conditioning facility, even when the term “heating facility” is used hereinafter.

The method is applied in a mixing device, in which two heating medium flows of different temperatures are mixed for adjusting the temperature of the heating medium. Such mixing take place for example in a floor heating system, in which cold heating medium from a return is admixed to a feed at a higher temperature, in order to reduce the heating medium temperature. Conversely, a necessary quantity of heated heating medium can be admixed to a heating medium which is delivered in the circulation, in order to increase the temperature of the heating medium which is delivered in the circulation. The mixing device, in which the method is applied, moreover comprises a circulation pump assembly which delivers the heating medium. According to the invention, one envisages regulating (closed-loop controlling) this circulation pump assembly in its speed in dependence on a temperature value which is detected in the heating medium. I.e. the circulation pump assembly comprises a speed regulation and in particular a speed controller, via which the speed is changeable. This can be effected for example via an electrical drive motor which is activated by way of a frequency converter. In known heating systems, the circulation pump assemblies are regulated in dependence on the flow rate and/or the pressure, i.e. the speed is adapted such that a desired flow rate and/or a desired pressure is reached at the outlet side of the circulation pump assembly. In contrast to this, according to the invention, a desired temperature is now to be reached and the circulation pump assembly is accordingly regulated in its speed in a temperature-dependent manner.

The speed of the at least one circulation pump assembly is preferably regulated in a manner such that the detected temperature value corresponds to a predefined temperature setpoint or approximates this, wherein the temperature setpoint is preferably specified in a manner depending on a room temperature and/or an outer temperature. The temperature setpoint can thus be determined via a heating curve which specifies the temperature setpoint in a manner depending on the outer temperature and/or room temperature, as is common with modern heating systems. According to this preferred embodiment of the invention, the desired temperature setpoint in the mixing device is achieved by way of a suitable speed adaptation of the circulation pump assembly. I.e., the speed of the circulation pump assembly is changed such that the detected temperature value approximates or approaches the temperature setpoint or ideally reaches this.

The two heating medium flows are preferably mixed at a run-out or mixing point and the temperature value is detected in the heating medium downstream of the mixing point. The heating medium temperature downstream of the mixing point can therefore be regulated or adapted by way of speed regulation or speed adjustment of the circulation pump assembly.

Further preferably, the at least one circulation pump assembly effects at least one of the two heating medium flows. I.e. the circulation pump assembly is arranged such that it delivers or circulates the heating medium. Here, the circulation pump assembly is preferably arranged downstream of a mixing point, so that it delivers mixed heating medium. This means that the mixing of the two heating medium flows is effected at the suction side of the circulation pump assembly.

According to a particular embodiment of the invention, the at least one circulation pump assembly which is regulated in its speed in dependence on a temperature value detected in the heating medium forms a first circulation pump assembly and a second circulation pump assembly which effects one of the heating medium flows is present. Here, the first circulation pump assembly can be arranged in one of the two heating medium flows or however, as described beforehand, downstream of the mixing point, so that it delivers the mixed heating medium flows. If the first circulation pump assembly which is regulated in its speed in a temperature-dependent manner is arranged downstream of the mixing point, then the second circulation pump assembly is preferably arranged such that it only effects one of the two heating medium flows. In this case, the second circulation pump assembly can be regulated for example in a pressure-dependent or flow-dependent manner. However, a reverse arrangement, in which the circulation pump assembly which is regulated in a temperature-dependent manner is only arranged in one of the two heating medium flows and a second circulation pump assembly which is regulated conventionally in a pressure-dependent or flow-rate-dependent manner is preferably arranged downstream of the mixing point is also conceivable.

Further preferably, the at least one circulation pump assembly effects at least one of the two heating medium flows, wherein the at least one circulation pump assembly preferably delivers the heating medium downstream of a mixing point of the two heating medium flows. The circulation pump assembly acts upon both heating medium flows if it is arranged downstream of the mixing point.

Further preferably, the at least one circulation pump assembly which is regulated in its speed in dependence on a temperature value which is detected in the heating medium forms a first circulation pump assembly, and a second circulation pump assembly which preferably acts in one of the heating medium flows is present. Thus for example the circulation pump assembly which is regulated in a temperature-dependent manner can be arranged downstream of a mixing point in the previously described manner and therefore act upon both heating medium flows, whereas a second circulation pump assembly acts in one of the heating medium flows and there provides a preliminary pressure upstream of the mixing point. Thus e.g. heated heat transfer medium can be fed at the mixing point in the manner of an injection circuit. However, it is also possible to provide two circulation pump assemblies or impellers, of which in each case one acts in one of the two heating medium flows, as has been described beforehand. According to a particular embodiment of the invention, only one of the circulation pump assemblies or the impellers can be changed in its speed for the regulation of the temperature, whereas the other circulation pump assembly or impeller is not regulated in its speed in a temperature-dependent manner, but is possibly only regulated in a pressure-dependent or flow-dependent manner or is not regulated at all. A very simple mixing regulation is realized in this manner, since only one impeller or one circulation pump assembly needs to be changed in its speed, in order to change the mixing ratio.

According to a further possible embodiment of the method according to the invention, the first circulation pump assembly is situated in a first of the two heating medium flows, preferably upstream of a mixing point and is regulated in its speed in dependence on a temperature value which is detected in the heating medium, in particular a temperature value which is detected downstream of the mixing point. The second circulation pump assembly with this embodiment example, in contrast is designed without a speed regulation for setting the temperature downstream of the mixing point. The second circulation pump assembly is preferably situated in the second heating medium flow. Hence it is e.g. possible to provide two circulation pump assemblies or impellers, of which in each case one acts in one of the two heating medium flows as has been described beforehand. Herein, only one of the cortication pump assemblies or of the impellers can be changed in its speed for temperature regulation, whereas the other circulation pump assembly or impeller is not regulated in its speed in a temperature-dependent manner or at least not in a directly temperature dependent manner, possibly only in a pressure-dependent or flow-dependent manner or is completely unregulated. In this manner, a very simple mixing regulation is realized, since merely one impeller or one circulation pump assembly needs to be changed in its speed, in order to change the mixing ratio and hence the temperature of the heating medium at or downstream of the mixing point.

The second circulation pump assembly can preferably be regulated in its speed in dependence on a pressure and/or a flow rate of the heating medium or however in dependence on a temperature value which is detected in the heating medium. On using two circulation pump assemblies in the previously described manner, it is therefore possible to regulate both in a temperature-dependent manner. However, it is also possible to regulate only one of the circulation pump assemblies in the described manner in dependence on a temperature value which is detected in the heating medium. This temperature-regulated circulation pump assembly for example can be a circulation pump assembly which is arranged downstream of the mixing point. However, it can also be circulation pump assembly which only acts in one of the heating medium flows. In the latter case, a circulation pump assembly which is arranged downstream of the mixing point can then for example be regulated in its speed conventionally only in a pressure-dependent and/or flow-rate-dependent manner. However, it is preferable for at least one of the existing circulation pump assemblies which acts hydraulically upon one or both heating medium flows of the mixing device to be regulated in a temperature-dependent manner in a heating system, in order to thus vary the mixing ratio between the heating medium flows by way of speed change of the circulation pump assembly and to therefore achieve a desired nominal temperature in a heating medium by way of regulating the circulation pump assembly.

According to a particular embodiment of the method according to the invention, one envisages carrying out a presetting, in particular a manual presetting of the system or of the mixing device before starting operation of the previously described temperature-dependent speed regulation of the circulation pump assembly, said presetting comprising the following steps. In a first step, the circulation pump assembly is set to a necessary differential pressure. It is thus ensured that the circulation pump assembly produces the necessary differential pressure for the respective heating circuit. I.e. a hydraulic adaptation of the setting of the circulation pump assembly to the facility is effected in this first step. In a next step, the two heating medium flows are manually adjusted such that a desired temperature of the heating medium is achieved. A feed temperature which would result according to a heating curve at given environmental conditions, for example at a given outer temperature, can be used as a desired temperature of the heating medium. This manual presetting of the heating medium flows is preferably effected via flow regulation valves which are provided in the pipe conduits for the heating medium flows and in particular can be integrated into the mixing device. Here, the valves are preferably manually adjustable. Different hydraulic resistances which act upon the two heating medium flow and are compensated by these presettings and a hydraulic basic setting is therefore carried out. After this presetting, the temperature regulation is then brought into operation by way of speed adaptation of the circulation pump assembly. On account of the performed presetting, slight changes in speed of the circulation pump assembly are then sufficient, in order to be able to carry out a temperature adaptation or regulation, for example by way of changing a mixing ratio in the mixing device.

Apart from the previously described method, the subject-matter of the invention is also a mixing device which is designed for use in a heating facility for mixing two heating medium flows. Here, the mixing device in particular is configured for carrying out the previously described method. The preceding description is thus referred to with regard to preferred features of the mixing device. Features which have been described there are likewise preferred features of the subsequently described mixing device.

The mixing device according to the invention comprises at least one circulation pump assembly which delivers the heating medium and which is adjustable in its speed, in particular can be regulated in its speed. For this, the circulation pump assembly preferably comprises an electrical drive motor with a speed controller, preferably whilst using a frequency converter. The electrical drive motor of the circulation pump assembly is preferably configured as a wet-running electrical drive motor, i.e. with a can or can pot between the rotor and the stator. The electrical drive motor rotatingly drives at least one impeller of the circulation pump assembly which is situated in a flow path for the heating medium. The mixing device moreover comprises a temperature sensor which is arranged in a manner such that it detects a temperature value of the heating medium. Here, the temperature sensor is preferably arranged on or in a flow path downstream of a mixing point, at which the two heating medium flows are mixed.

According to the invention, the circulation pump assembly is provided with a control device which is configured such that it adjusts the speed of the circulation pump assembly, i.e. of the at least one impeller of the circulation pump assembly in dependence on a temperature value which is detected by the temperature sensor. The control device is configured such that it carries out a temperature-dependent speed adjustment or speed regulation of the circulation pump assembly. In this manner, a desired temperature value for the heating medium can be set or adjusted by way of speed change.

Preferably, the mixing device comprises a mixing point or run-out point, at which the two heating medium flows are mixed. Here, the at least one circulation pump assembly is preferably arranged in a flow path downstream of this mixing point. The circulation pump assembly thus acts upon both heating medium flows since these are mixed at the suction side of the circulation pump assembly.

The at least one circulation pump assembly which is regulated in its speed in dependence on a temperature value which is detected in the heating medium, by way of the control device, is preferably a first circulation pump assembly, and moreover a second circulation pump assembly which further preferably is situated in one of the heating medium flows is present in the mixing device. The circulation pump assembly which is regulated in a temperature-dependent manner is therefore preferably arranged downstream of a mixing point, whereas the second circulation pump assembly only acts in one of the heating medium flows, so that this heating medium flow is fed to the mixing point at a preliminary pressure. This second circulation pump assembly can further preferably be arranged in a heating boiler or a heat source and/or additionally serve for the supply of a further heating circuit. An injection circuit is therefore realized on feeding the heating medium to the mixing point at a preliminary pressure. The preliminary pressure can contribute to causing a change of the mixing ratio via the temperature-dependent speed regulation of the first circulation pump assembly by way of changing the hydraulic resistances in the mixing device.

The second circulation pump assembly further preferably comprises a control device which is independent of the first circulation pump assembly and which is preferably configured in a manner such that it adjusts the speed of the second circulation pump assembly in dependence on a pressure and/or flow rate of the heating medium. Alternatively or additionally, it is possible for the control device to be configured in a manner such that it adjusts the speed of the second circulation pump assembly in dependence on the temperature of the heating medium. In a particular embodiment there therefore exists the possibility of regulating only one circulation pump assembly, in one of the two heating medium flows, in its speed in a temperature-dependent manner, whereas a possibly present second circulation pump assembly acts upon both heating medium flows and is regulated in its speed in a pressure-dependent or flow-rate-dependent manner in the conventional way. The independent control device for the second circulation pump assembly has the advantage that the mixing device with the control device for the temperature-dependent speed regulation of the first circulation pump assembly can be realized independently and can be easily integrated into an existing heating system which already comprises a circulation pump assembly. The circulation pump assembly which is present in the heating system in any case then forms the described second circulation pump assembly.

In an alternative embodiment, the first and the second circulation pump assembly can comprise a common control device and/or two controls devices which communicate with one another and which are configured in a manner such that the first and the second circulation pump assembly are regulated in their speeds in dependence on the temperature value which is detected by the at least one temperature sensor. Should two control devices which communicate with one another be provided, then these comprise suitable communication interfaces for data exchange. The communication interfaces can be configured in a wire-connected or also wireless manner, for example as wireless LAN, Bluetooth or other suitable wireless interfaces. An even more accurate temperature adaptation and/or also a greater regulation range can be realized by the speed regulation of both circulation pump assemblies in dependence on a detected temperature value.

The first or the second circulation pump assembly are preferably arranged such that it additionally supplies a further heating circuit with heating medium. If the second circulation pump assembly is a circulation pump assembly which is assigned for example to a heating boiler or to a heating facility as described beforehand by way of example, then this circulation pump assembly can supply heating circuits which are operated at a higher feed temperature, whereas the described first circulation pump assembly of the mixing device then preferably supplies one or more heating circuits with a lower feed temperature, in particular heating circuits of a floor heating.

The mixing device preferably comprises two inlets for both heating medium flows, wherein an adjusting valve for adjusting the flow through the respective inlet is arranged at at least one of the two inlets and preferably at both inlets. These adjusting valves are further preferably manually actuatable valves. These adjusting valves permit the presetting of the mixing device which is described above by way of the method, so that the hydraulic output of the circulation pump assembly can be adapted to the facility demand and different hydraulic resistances in the flow paths for the two heating medium flows can be simultaneously compensated by presetting, so an optimal regulation range can be reached by way of the described speed regulation with the help of the control device.

The invention is hereinafter described by way of example and by way of the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a hydraulic circuit diagram of a heating facility according to the state of the art;

FIG. 2 is a hydraulic circuit diagram of a heating system according to a first embodiment of the invention;

FIG. 3 is a hydraulic circuit diagram of a heating facility according to a second embodiment of the invention;

FIG. 4 is a hydraulic circuit diagram of a heating system according to a third embodiment of the invention;

FIG. 5 is a hydraulic circuit diagram of a heating facility according to the embodiment example according to FIG. 3, with a double impeller;

FIG. 6 is an exploded view of a circulation pump assembly with a mixing device according to the heating system according to FIGS. 2, 3, and 5;

FIG. 7 is a sectional view of the circulation pump assembly according to FIG. 6 along its longitudinal axis X;

FIG. 8 is a plan view of the rear side of the circulation pump assembly according to FIGS. 6 and 7;

FIG. 9 is a partial sectional view of the rear side of the circulation pump assembly according to FIG. 6 to 8;

FIG. 10 is an exploded view of a circulation pump assembly with a mixing device according to the embodiment example according to FIG. 4;

FIG. 11 is a sectional view of the circulation pump assembly according to FIG. 10, along its longitudinal axis X;

FIG. 12 is a plan view of the rear side of the circulation pump assembly according to FIGS. 9 and 10;

FIG. 13 is a graph of the pressure course over the speed for the embodiment example of a heating system according to FIG. 2;

FIG. 14 is a graph of the pressure course over the speed for an embodiment example of a heating system according to FIG. 3; and

FIG. 15 is a graph of the pressure course over the speed for an embodiment example of a heating system according to FIG. 4.

### DESCRIPTION OF PREFERRED EMBODIMENTS

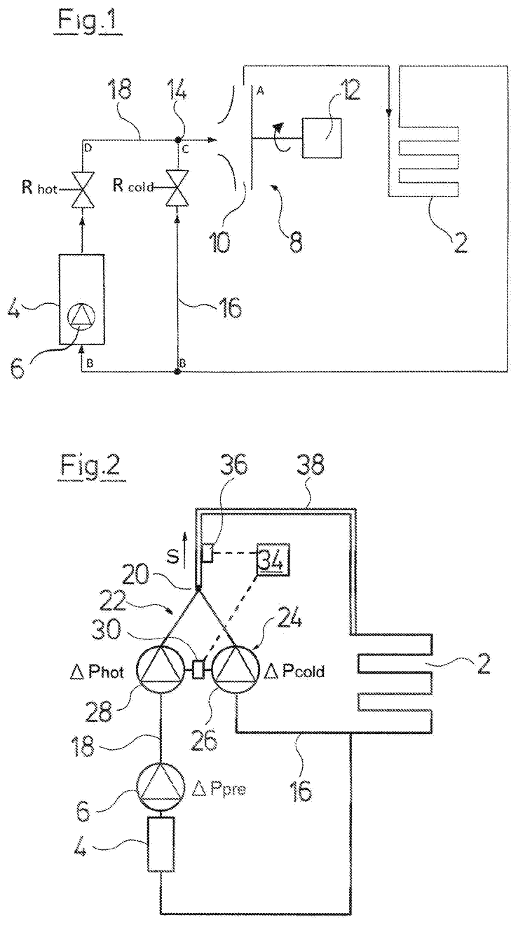

Referring to the drawings, FIG. 1 schematically shows a conventional heating circuit for a floor heating 2, i.e. a heating circuit according to the state of the art. A heating boiler 4, for example a gas heating boiler with an integrated circulation pump 6 serves as a heat source. Such combinations are known on the market as compact heating facilities. A further circulation pump assembly 8 with an impeller 10 as well as with an electrical drive motor 12 is provided for the floor heating circuit 2. Here, a mixing device is provided since the heating boiler 4 has too high a feed temperature for the floor heating 2, wherein this mixing device has a mixing point 14 which is situated at the suction side of the impeller 10. A return conduit 16 of the floor heating circuit 2 runs out at the mixing point 14. A feed conduit 18, via which the water or heating medium which is heated by the boiler 4 is fed and injected at the mixing point 14 by the pressure produced by the circulation pump assembly 6 runs out at the mixing point or run-out point 14. In this example, two flow regulation valves Rₕₒₜ and R_{cold} are provided for regulating the mixing ratio. The regulating valve Rₕₒₜ is arranged in the feed conduit 18 and the regulating valve R_{cold} in the return conduit 16. The valves can be activated for example by a control device via an electrical drive. The regulating valves Rₕₒₜ and R_{cold} can preferably be coupled such that one of the valves is always opened and the other valve is simultaneously closed by the same amount, for changing the flow rate. A 3-way valve which comprises a valve element which by way of its movement simultaneously closes the return conduit 16 and opens the feed conduit 18 or vice versa can also be used instead of two flow regulation valves R. The circulation pump assembly 6 can moreover supply a further heating circuit which is not shown here and which is operated directly with the feed temperature produced by the heating boiler. The circulation pump assembly 6 as well as the circulation pump assembly 8 can have a conventional pressure regulation or flow-rate regulation. Concerning the known system, it is a disadvantage that the flow regulation valves R are necessary for adjusting the mixing ratio and need to be provided with a suitable drive, for example with a motorically or thermostatically actuated drive. The flow regulation valves R are regulated such that a desired feed temperature for the floor heating 2 is reached downstream of the mixing point 14. A further disadvantage in this system is the fact that the pressure which is produced by the circulation pump assembly 6 needs to be reduced via the flow regulation valve Rₕₒₜ, in order to achieve the suction-side pressure of the impeller 10 at the mixing point 14. An energy loss thus occurs in the system, and this loss can be avoided with the solution according to the invention which is described hereinafter.

Concerning the three solutions according to the invention which are described by way of example and are schematically represented in FIG. 2 to 4, the mixing ratio for achieving a desired feed temperature for the floor heating 2 is achieved solely by way of a speed regulation of a circulation pump assembly. This assembly comprises two flow paths which mutually hydraulically influence one another such that the hydraulic resistance in at least one of the flow paths can be changed by way of a speed change, in order to change the mixing ratio as is described hereinafter.

FIG. 2 shows a first embodiment example of the invention. In this, again a heating boiler 4 is provided for heating a fluid heating medium, i.e. a fluid heat-transfer medium such as water. A circulation pump assembly 6 is moreover arranged on this boiler 4 and could also be integrated into the heating boiler 4, as has been explained regarding FIG. 1. The circulation pump assembly 6 delivers heat transfer medium in a feed conduit 18. A floor heating 2 or a floor heating circuit 2 is moreover provided and this comprises a return which on the one hand is connected to the inlet side of the heating boiler 4 and on the other hand leads via a return conduit 16 to a mixing point 20, at which the feed conduit 18 also runs out. The mixing point or run-out point 20 is part of a mixing device 22 and moreover of a circulation pump assembly 24. The mixing device 22 and the circulation pump assembly 24 can form an integrated construction unit, so that the mixing device 22 is part of the circulation pump assembly 24 or the circulation pump assembly 24 is part of the mixing device. In particular, the mixing point 20 can lie directly in the pump casing or in an impeller of the circulation pump assembly 24, as is described hereinafter.

In the embodiment example according to FIG. 2, the circulation pump assembly 24 is configured as a double pump with two impellers 26 and 28. The impellers 26 and 28 are driven via a common drive motor 30. The impellers 26 and 28 can be configured as separate impellers or as an integrated impeller with two blade arrangements or flow paths. The first impeller 26 forms a first flow path and lies in a first flow connection in the mixing device from the return conduit 16 to the mixing point 20. The second impeller 28 forms a second flow path and lies in a second flow connection between the feed conduit 18 and the mixing point 20. The mixing point 20 therefore lies at the delivery side of the two impellers 26 and 28, i.e. according to the invention, the two heating medium flows are mixed with one another after a pressure increase.

The drive motor 30 is controlled or regulated by a control device 34 which serves for speed regulation or speed control of the drive motor 30 and is configured such that it can change the speed of the drive motor 30. For this, the control device 34 comprises a speed controller, in particular amid the application of a frequency converter. The control device 34 can be integrated directly into the drive motor 30 or be arranged in an electronics casing directly on the drive motor and in particular on the motor casing of this motor. The control device 34 is moreover connected to a temperature sensor 36 or communicates with a temperature sensor 36. The temperature sensor 36 is situated downstream of the mixing point 20 on or in the feed conduit 38 which connects the mixing point 20 to the floor heating circuit 2. Here, the temperature sensor 36 can be integrated into the mixing device 22 or into the circulation pump assembly 24. The connection of the temperatures sensor 36 to the control device 34 can be provided in an arbitrary manner, for example connected by wire or also in a wireless manner. A wireless connection can be realized for example via a radio connection such as Bluetooth or W-LAN.

The temperature sensor 36 transmits a temperature value of the heating medium downstream of the mixing point 20 to the control device 34, so that this can carry out a temperature regulation. According to the invention, the drive motor 30 and therefore the circulation pump assembly 34 is not regulated in a pressure-dependent or flow-rate-dependent manner, but in a temperature-dependent manner. I.e. the control device 34 adapts the speed of the drive motor 30 such that a desired temperature of the heating medium is reached downstream of the mixing point 20. The desired temperature is defined by a temperature setpoint which can be set in a fixed manner, can be manually adjusted or can be specified depending on the outer temperature by a heating curve which is stored in the control device 34 or a superordinate control. The control device 34 varies the speed of the drive motor 30, by which means, as described hereinafter, the mixing ratio of the heating medium flows which are mixed at the mixing point 20 changes, so that the temperature downstream of the mixing point 20 changes. This temperature is detected by the temperature senor 36, so that the control device 34 can carry out a temperature regulation by way of speed variation of the drive motor 30, in order for the temperature value downstream of the mixing point 20 to approximate the temperature setpoint.

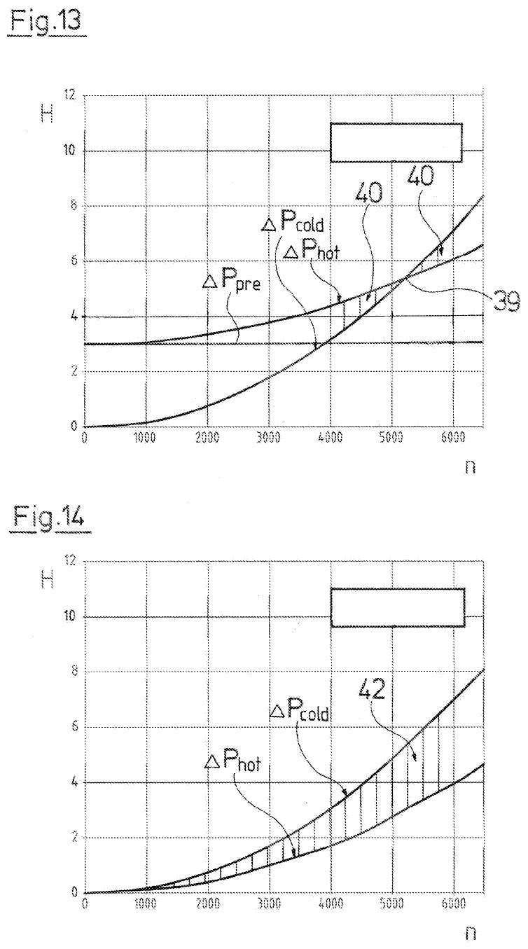

The variation of the mixing ratio at the mixing point 20 via the speed change is explained in more detail by way of FIG. 13. In FIG. 13, the delivery head H, i.e. the pressure is plotted against the speed n of the drive motor 30. In the example which is shown in FIG. 2, there are three differential pressure values ΔPₚᵣₑ, ΔPₕₒₜ and ΔP_{cold}. The differential pressure ΔPₚᵣₑ is produced by the circulation pump assembly 6 and in this case cannot be influenced by the mixing device 22, so that it is represented in FIG. 13 as a constant preliminary pressure, i.e. one which is independent of the speed of the drive motor 30. The impeller 26 of the circulation pump assembly 24 produces a differential pressure ΔP_{cold} for the return of the floor heating 2 and the impeller 28 produces a differential pressure ΔPₕₒₜ for the feed from the feed conduit 18. As is to be recognized in FIG. 13, the impellers 26 and 28 are configured differently, so that they have different pressure courses, i.e. different speed-dependent pressure courses. The pressure course for the impeller 28 is less steep than the pressure course of the impeller 26. This can be achieved for example by way of the impeller 26 having a larger outer diameter. The differential pressures ΔPₚᵣₑ and ΔPₕₒₜ moreover sum for the heated heating medium which is fed through the feed conduit 18, so that the curve of the pressure course ΔPₕₒₜ is shifted to the top in the diagram by a constant value. One succeeds in the pressure course curves ΔPₕₒₜ and ΔP_{cold} intersecting at a point 39 by way of this. Mixing regions 40 for the mixed fluid result above and below the intersection point of these curves. Given a speed n below the intersection point 39 of the two pressure course curves, the outlet pressure of the impeller 28 is higher than that of the impeller 26, so that the outlet pressure of the impeller 28 in the flow path through the impeller 26 acts at the mixing point 20 as a counter-pressure and a hydraulic resistance and in this operating condition the flow rate through the first flow path through the impeller 26 is reduced and more heated heating medium is admixed, in order to reach a higher temperature in the feed 38 to the floor heating circuit 2. If the speed is increased, then the outlet pressure of the impeller 26 is greater than that of the impeller 28 above the intersection point 39 of the two pressure course curves, so that a hydraulic resistance in the form of a counter-pressure is produced at the mixing point 20 in the second flow path through the impeller 28 and the flow rate through the second flow path is reduced, by which means less heated heating medium is fed at the mixing point 20 and the temperature at the outlet side of the mixing point 20 can be reduced.

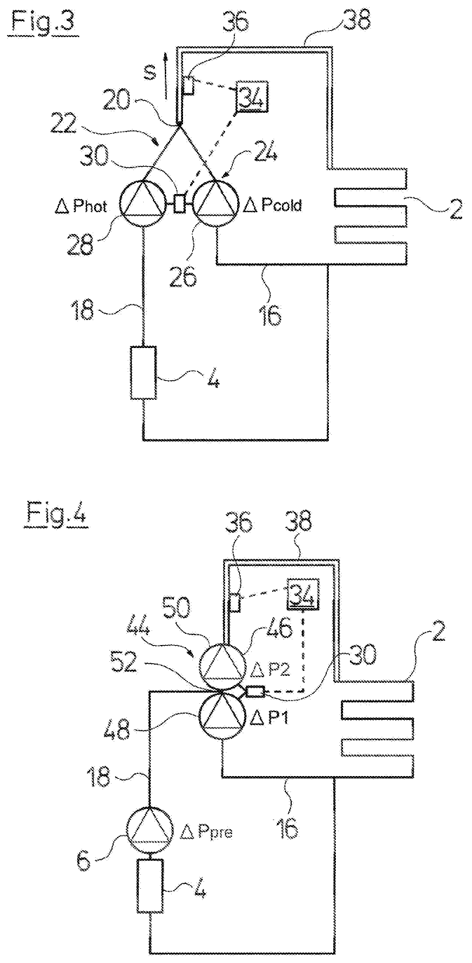

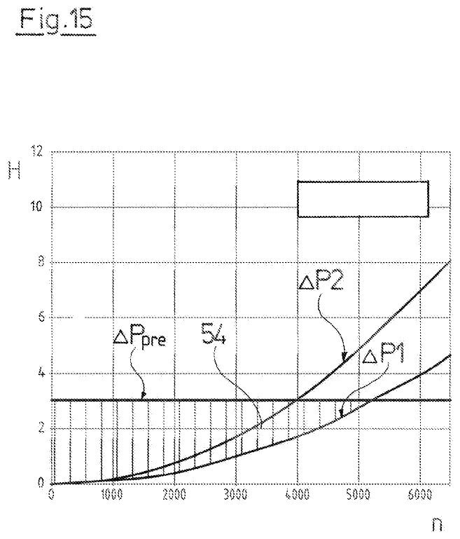

FIG. 3 shows a further variant of a mixing device according to the invention or of a heating system according to the invention, which differs from the heating system according to FIG. 2 in that no circulation pump assembly 6 is provided in the feed 18. I.e. the heated heating medium is fed to the circulation pump assembly 24 via the feed conduit 18 without a preliminary pressure. The curves of the pressure course which are shown in FIG. 14 result on account of this. Again, in FIG. 14 the delivery head H, i.e. the pressure is plotted against the speed n of the drive motor 30. The pressure course curves ΔP_{cold} and ΔPₕₒₜ correspond to the pressure course curves which are shown in FIG. 13. It is only the constant preliminary pressure ΔPₚᵣₑ which is absent, so that the pressure course curve ΔPₕₒₜ is not shifted upwards in the diagram, but begins at the origin just as the pressure course curve ΔP_{cold}. However, both curves have a different gradient which again, as described above, is achieved by a different impeller diameter of the impellers 26 and 28. The hydraulic resistances change due to the fact that the differential pressure at the impellers 26 and 28 changes to a different extent given a change in speed, by which means a mixing region 42 results between the two pressure course curves with a resulting differential pressure. The higher outlet pressure ΔP_{cold} of the impeller 26 acts as a hydraulic resistance in the second flow path through the impeller 28 at the mixing point 20. The hydraulic resistance results from the pressure difference between the outlet pressures of the impellers 26 and 28 at the mixing point 20. As can be recognized in FIG. 14, this pressure difference between the pressure course curves ΔP_{cold} and ΔPₕₒₜ (the mixing region 42) is speed-dependent. I.e. the hydraulic resistance which acts in the flow path through the impeller 28 can thus also be varied by way of speed change, so that the flow rate through the impeller 28 and thus the flow rate of heated heating medium can be changed. A change of the temperature at the outlet side of the mixing point 20 and, with this, a temperature regulation is therefore also possible by way of a speed change of the speed n of the drive motor 30.

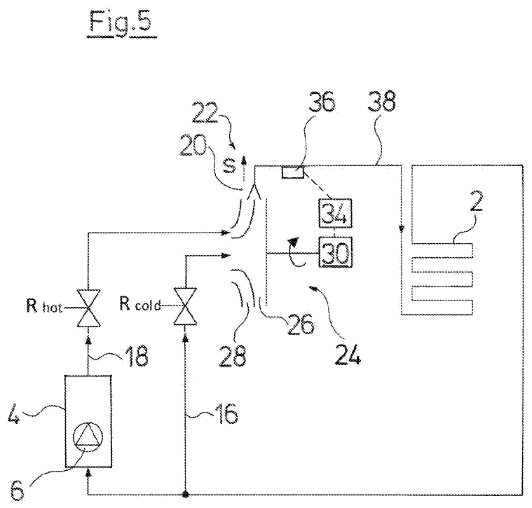

FIG. 5 shows an embodiment example which represents one variant of the embodiment example which is shown in FIG. 2. The two impellers 26 and 28 are configured in the form of a double impeller. I.e. the impeller 26 is formed by a first blade ring and the impeller 28 by a second blade ring of the same impeller. The variation of the mixing ratio at the mixing point 20 via a change of the speed n of the drive motor 30 is effected in the same manner as described by way of FIGS. 3 and 13. In this embodiment example, a flow regulation valve Rₕₒₜ is additionally provided in the feed conduit 18 and as well as a flow regulation valve R_{cold} in the return conduit 16, upstream of the impellers 26 and 28. These are manually adjustable valves, with which a presetting can be carried out before the described speed regulation control is carried out. The presetting is preferably effected in a manner such that the speed of the drive motor 30 is firstly set such that an adequate flow rate through the floor circuit 2 is achieved. I.e.

the speed of the impellers 26 and 28 is firstly set such that a differential pressure which is matched to the facility, i.e. to the hydraulic resistance of the facility, is produced. The manual flow regulation valves Rₕₒₜ and R_{cold} are subsequently adjusted or set such that a desired temperature setpoint is reached at the temperature sensor 36 at the given speed. This temperature setpoint for example can be a temperature setpoint which is set by a heating curve given the current outer temperature. A compensation between the different hydraulic resistances in the feed conduit 18 and the return conduit 16 is achieved by the manual presetting. After this presetting, the temperature regulation can they be carried out by way of speed regulation with the help of the control device 34, wherein only slight speed changes are necessary for temperature adaptation, as results from the diagram in FIG. 13. Such valves for presetting can also be used with the other described embodiments examples.

FIG. 4 shows a third variant of a heating system with a mixing device according to the invention. A heating boiler 4 with a circulation pump assembly 6 which is arranged downstream is also provided in this heating system. A floor heating 2 or a floor heating circuit 2 which is to be supplied is also provided. Here too, a mixing device 44 is present, in which mixing device a heating medium flow from a feed 18 which extends in a manner departing from the heating boiler 4 is mixed with a heating medium flow from a return conduit 16 from the return of the floor heating 2. In this embodiment example, the mixing device 44 again comprises a circulation pump assembly 46 with an electrical drive motor 30. This drive motor 30 is also regulated in its speed by the control device 34 which can be integrated directly into the drive motor 30 or in an electronics casing directly on the drive motor 30. As with the preceding embodiment examples, the control device 34 is communicatingly connected to a temperature sensor 36 which is situated on a feed conduit 38 to the floor heating circuit 2, so that it detects the feed temperature of the heating medium which is fed to the floor heating circuit 2. A temperature-dependent speed control can therefore also be carried out with regard to the circulation pump assembly 36 in the manner described above.

The embodiment example according to FIG. 4 differs from the previously described embodiment examples in that the circulation pump assembly although comprising no impellers arranged in parallel however comprises impeller parts 48 and 50 which are arranged in series. The impeller parts 48 and 50 can be configured as two separate impellers which are connected to one another in a rotationally fixed manner, so that these are rotatingly driven via the common drive motor 30. Particularly preferably, the impeller parts 48, 50 are however configured as an impeller which between a first central inlet opening and the outlet opening comprises at least one second inlet openings in a radially middle region, as described in more detail below. Concerning this embodiment example, this second inlet opening forms the mixing point or run-out point 52, at which the two flow fluid flows or heating medium flows from the return conduit 16 and the feed conduit 18 are mixed. The heating medium flow from the return conduit 16 undergoes a first pressure increase ΔP₁ upstream of the mixing point 52 via the impeller part 48. The heating medium flow from the feed conduit 18 undergoes a pressure increase ΔPₚᵣₑ by way of the circulation pump assembly 6. At the run-out point 52, the heating medium flow is injected at this preliminary pressure into the heating medium flow which leaves the impeller part 48. The run-out point 52 and the second impeller part 50 form a second flow path. The heating medium flow from the feed conduit 18 and, in the further course downstream of the run-out point 52, also the heating medium flow which is from the return conduit 16 and which has previously undergone a pressure increase in a first flow path in the impeller part 48, flow through this second flow path. The mixed heating medium flow undergoes a further pressure increase ΔP₂ in the impeller part 50.

With this configuration too, the mixing ratio between the heating medium flow from the return conduit 16 and the heating medium flow from the feed conduitl8 can be changed by way of a speed change, as is described in more detail by way of FIG. 15. In FIG. 15, the pressure courses in the form of the delivery head H are again plotted against the speed n of the drive motor 30. The constant preliminary pressure ΔPₚᵣₑ which is produced by the circulation pump assembly 6 is to be recognized as a horizontal line in the diagram in FIG. 15. Moreover, the two speed-dependent pressure courses ΔP₁ and ΔP₂ are again shown. Here, the pressure course ΔP₂ has a steeper course than the pressure course ΔP₁, i.e. given an increase of the speed, the pressure ΔP₂ rises more rapidly than the pressure ΔP₁. A mixing region 54, in which different mixing ratios can be realized is located between the pressure course ΔP₁ and the preliminary pressure ΔPₚᵣₑ. The hydraulic resistance in the second flow path to the impeller part 50 increases at the mixing point 52 with an increasing pressure ΔP₁ which the heating medium flow from the return conduit 16 undergoes in the impeller part 48. A counter-pressure forms at the mixing point 52 and this counter-pressure serves as a hydraulic resistance for the heating medium flow which enters into the mixing point 52 from the feed conduit 18. The higher the counter-pressure at the mixing point 52, the lower becomes the flow rate through this second flow path through the run-out point 52, i.e. the smaller does the heating medium flow which enters from the feed conduit 18 into the mixing point 52 and thus into the second flow path become. The warm water flow, i.e. the heating medium flow from the feed conduit 18 is completely disconnected when the preliminary pressure ΔPₚᵣₑ is exceeded by the pressure ΔP₁. The mixing ratio can therefore be changed by way of speed change. The mixed heating medium flow then undergoes the pressure increase to the pressure ΔP₂ in the second impeller part 50.

This arrangement has the advantage that the pressure ΔPₚᵣₑ which is produced by the circulation pump assembly 6 does not have to be reduced, since the mixing of the two heating medium flows takes place at a greater pressure level, specifically at the level of the pressure ΔP₁. Energy losses in the mixing device 44 are reduced by way of this.

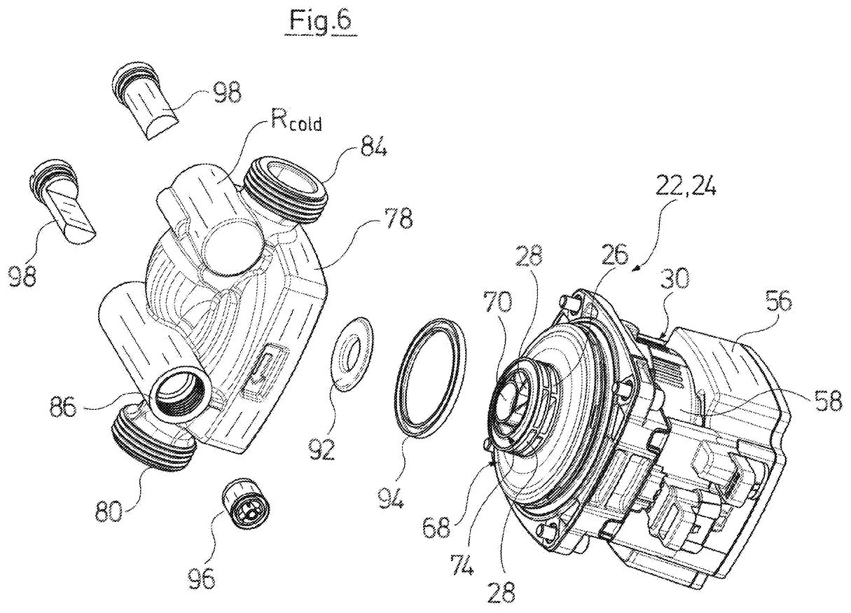

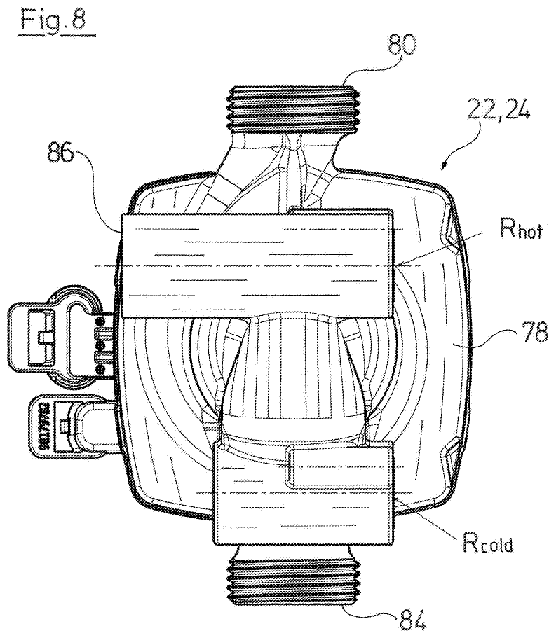

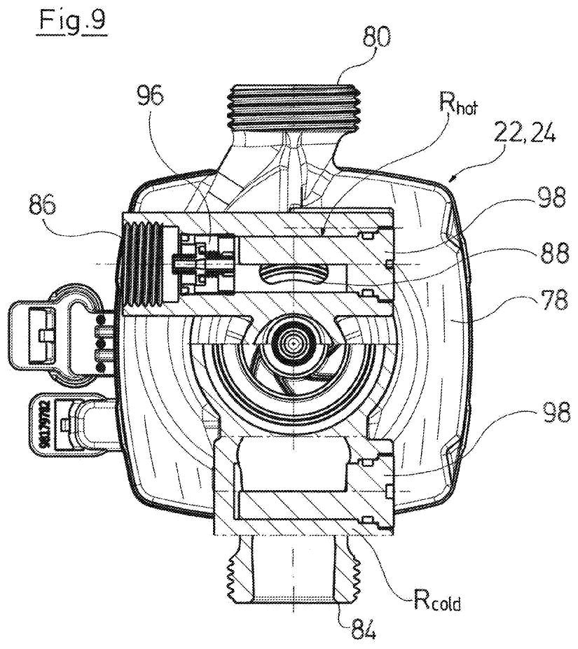

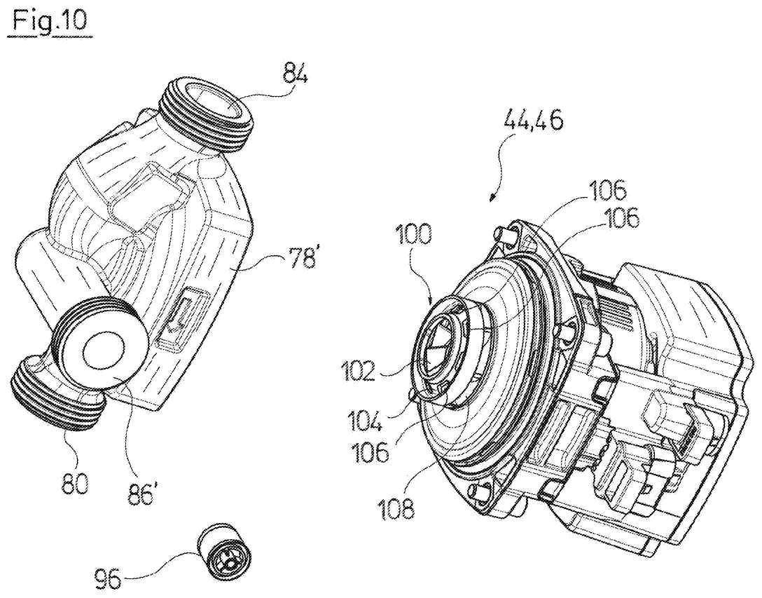

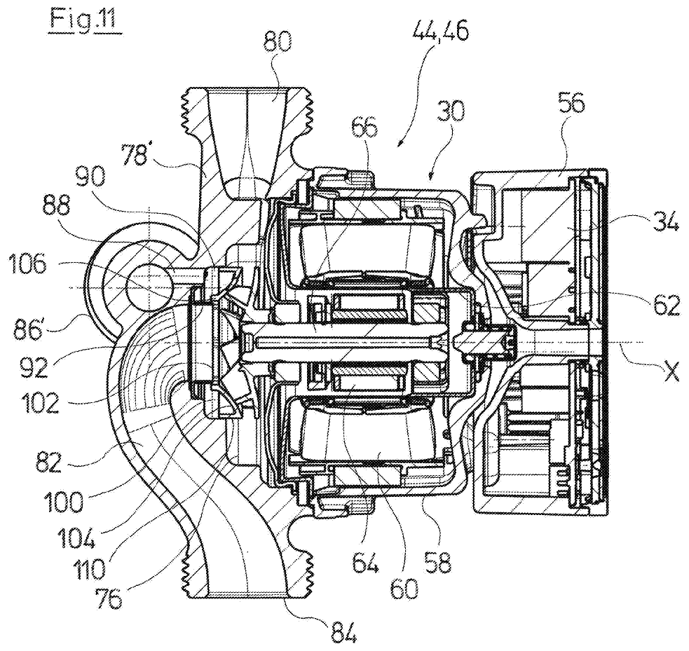

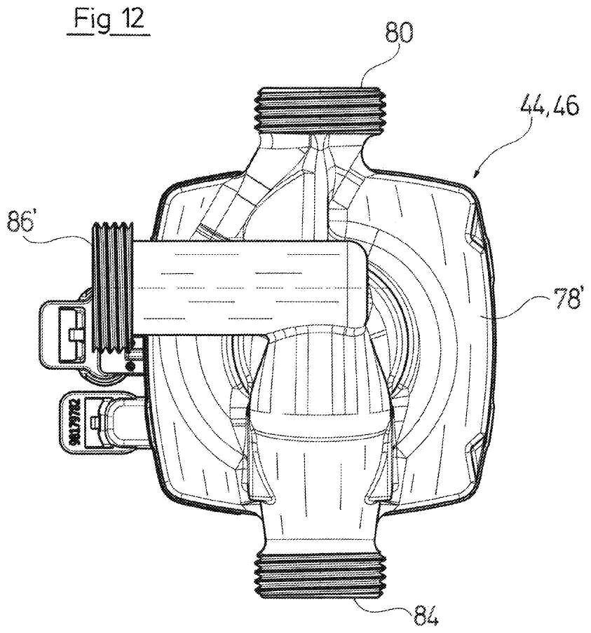

The design construction of the mixing devices 22 and 44 are hereinafter described in more detail by way of the FIGS. 6 to 12. Here, FIGS. 6 to 9 show a mixing device which is used as a mixing device 22 in the embodiment examples according to FIGS. 2, 3 and 5. FIGS. 10 to 12 show a mixing device 44 as is applied with the embodiment example according to FIG. 4.

The embodiment example according to FIG. 6 to 9 shows an integrated circulation pump mixing device, i.e. a circulation pump assembly with an integrated mixing device or a mixing device with an integrated circulation pump assembly. The circulation pump assembly in the known manner comprises an electrical drive motor 30, on which an electronics casing or terminal box 56 is attached. In this embodiment example, the control device 34 is arranged in the electronics casing. The electrical drive motor comprises a stator or motor casing 58, in whose interior the stator 60 of the drive motor 30 is arranged. The stator 60 surround a can pot or can 62 which separates the stator space from a centrally situated rotor space. The rotor 64 which can be configured for example as a permanent magnet rotor is arranged in the rotor space. The rotor 64 is connected to the impeller 68 via a rotor shaft 66, so that the rotor 64, given its rotation about the rotation axis X, rotatingly drives the impeller 68.

In this embodiment example, the impeller 68 is configured as a double impeller and unifies the impellers 26 and 28, as has been described by way of FIGS. 2 and 5. The impeller 68 comprises a central suction port 70 which runs out into a first blade arrangement or into a first blade ring which forms the impeller 26. A first flow path through the impeller 68 is therefore defined by the suction port 70 and the impeller 26. The impeller 26 is configured in a closed manner and comprises a front shroud 72 which merges into a collar which delimits the suction port 70. A second blade ring which forms the second impeller 28 is arranged or formed on the front shroud 72. The second impeller 28 at the inlet side comprises an annular suction port 74 which annularly surrounds the suction port 70. The second suction port 74 forms a second inlet opening of the impeller 68. Departing from the second suction port 74, the impeller 28 forms a second flow path through the impeller 68. The impeller 26 as well as the impeller 28 comprises outlet openings at the peripheral side, said outlet openings running out into a delivery chamber 76 of a pump casing 78.

The pump casing 78 is connected to the motor casing 58 in the usual manner. The delivery chamber 76 in the inside of the pump casing 78 runs out into delivery pipe connection 80, onto which the feed conduit 38 to the floor heating circuit 2 would connect in the embodiment examples according to FIGS. 2, 3 and 5. Since both impellers 26 and 28 run out into the delivery chamber 76, the mixing point 20 which is described by way of FIGS. 2, 3 and 5 lies at the outlet side of the impeller 68 in the delivery chamber 76 of the pump casing 78.

The first suction port 70 of the impeller 68, in the pump casing 78 is in connection with a first suction conduit 82 which begins at a first suction pipe connection 84. This first suction pipe connection 84 lies in a manner in which it is axially aligned to the delivery pipe connection 80 along an installation axis which extends normally to the rotation axis X. In the embodiment examples according to FIGS. 2, 3, and 5, the return conduit 16 is connected to the suction pipe connection 16. In this embodiment example, a flow regulation valve R_{cold} as is shown in FIG. 5 is moreover arranged in the suction conduit 82.

A first flow connection through the pump casing 78 is defined from the suction pipe connection 84 which forms a first inlet, via the suction conduit 82, the suction port 70, the first impeller 26, the delivery chamber 76 and the delivery pipe connection 80. The pump casing 78 moreover comprises a second suction pipe connection 86 which forms a second inlet. In the inside of the pump casing 78, the second suction pipe connection is connected to an annular space 90 at the suction side of the impeller 68 via a connection channel 88. The annular space 90 surrounds a ring element 92 at the outer periphery. The ring element 92 is inserted into the suction chamber of the pump casing 78 and with its annular collar is in engagement with the collar which surrounds the suction port 70, so that a sealed flow connection is created from the suction channel 82 into the suction port 70. The ring element 92 is surrounded by the annular space 90 at the outer periphery, so that the ring element 92 separates the flow path to the suction port 70 from the flow path to the second suction port 74. An annular sealing element 94 which bears on the inner periphery of the pump casing 78 and comes into sealing bearing contact with the outer periphery of the impeller 68 is inserted into the pump casing. Here, the sealing element 94 is in sealing bearing contact with the impeller 68 in the outer peripheral region of the second suction port 74, so that in the pump casing it separates the suction region from the delivery chamber at the inlet side of the suction port 74.

A check valve 96 which prevents a backflow of fluid into the feed conduit 18 is moreover arranged in the flow path from the second suction pipe connection 86 to the connection channel 88. The feed conduit 18, as is shown in FIGS. 2, 3 and 5, is connected onto the second suction pipe connection 86.

A temperature adjustment of the heating medium which is fed to the floor heating circuit 2 can be achieved with the shown circulation pump assembly 24 with the integrated mixing device 22 by way of a speed change of the drive motor 30, as was described by way of FIGS. 2, 3 and 5 as well as 13 and 14.

A presetting can be carried out via the flow regulation valves R_{cold} and Rₕₒₜ, as described by way of FIG. 5. In this embodiment example, the flow regulation valves R_{cold} and Rₕₒₜ are configured as rotatable valve elements 98 which are each inserted into a cylindrical receiving space. The valve elements 98 get into the suction conduit 82 to a different extent or cover the connection channel 88, by way of rotation, so that the free flow cross section in the first or second flow path can be changed by way of rotating the respective valve element 98.

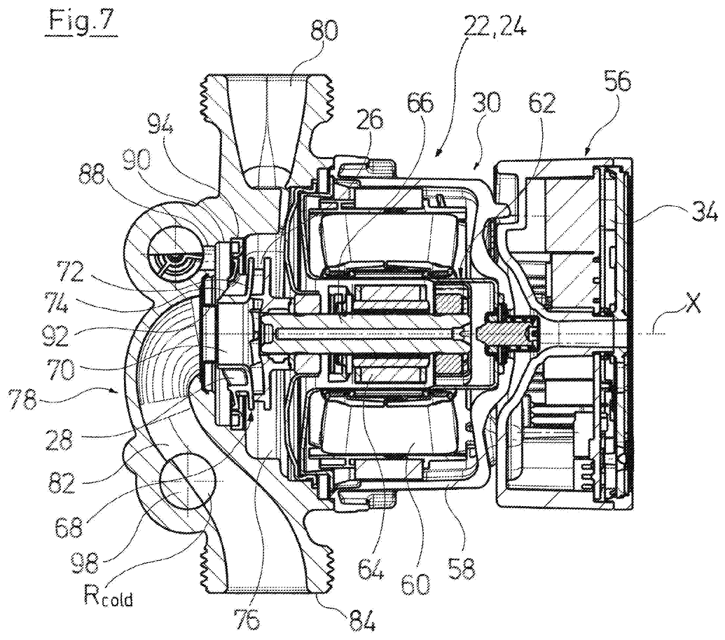

FIG. 10 to 12 show an embodiment example of the circulation pump assembly 46 with the mixing device 44 as has been described by way of FIGS. 4 and 15. Here too, the mixing device 44 and the circulation pump assembly 46 represent an integrated construction unit. The drive motor 30 with the attached electronics casing 56 with regard to one construction corresponds to the drive motor 30 as has been described by way of FIG. 7 to 9. The pump casing 78′ with regard to its construction also corresponds essentially to the previously described pump casing 78. A first difference lies in the fact that the pump casing 78′ has no flow regulation valves Rₕₒₜ and R_{cold}, wherein it is to be understood that such flow regulation valves R as have been described beforehand could also be provided in this second embodiment example. A second difference lies in the fact that the second suction pipe connection 86′ in this embodiment example has an outer thread. However, it is to be understood that the suction pipe connection 86 according to the preceding embodiment example could also be configured accordingly or the suction pipe connection 86′ could likewise comprise an inner thread.

In the second embodiment example, an impeller 100 is connected to the rotor shaft 66. This impeller 100 comprises a central suction port 102 whose peripheral edge is sealingly engaged with the ring element 92, so that a flow connection is created from the first suction pipe connection 84 into the impeller 100. The impeller 100 comprises only one blade ring which defines a first flow path departing from the suction port 102 which forms a first inlet opening, to the outer periphery of the impeller 100. This first flow path runs out into the delivery chamber 76 which is connected to the delivery pipe connection 80. An annular space 90, into which the connection channel 88 runs out from the second suction pipe connection 86 is again present surrounding the ring element 92. The impeller 100 comprises front shroud 104. Openings 106 which form second inlet openings are formed in this shroud. These openings 106 run out into the flow channels 108 between the impeller blades. Here, the openings 106, seen radially with respect to the rotation axis X, run out into the flow channels 108 in a region between the suction port 102 and the outer periphery of the impeller 100. I.e. the openings 106 run out into a radial middle region of the first flow path through the impeller 100. The openings 106 and the flow channels 108 with their sections radially outside the openings 106 form second flow paths which correspond to the impeller part 50 as has been described by way of FIG. 4. The impeller part 78 is formed by the radially inwardly lying impeller part, i.e. in the flow direction between the suction port 102 and the openings 106. The openings 106 face the annular space 90 so that heating medium can enter these openings 106 via the connection channel 88. In this embodiment example, the mixing point 52 according to FIG. 4 therefore lies in the flow channels 108 at the outlet side of the opening 106.

The impeller 100 on its outer periphery, i.e. on the outer periphery of the shroud 104 comprises an axially directed collar 110 which bears on the inner periphery of the pump casing 78′ and therefore seals the annular space 90 with respect to the delivery chamber 76. A temperature regulation of the heating medium flow which is fed to the floor heating circuit 2 can be carried out as is described by way of FIGS. 4 and 15, with the circulation pump assembly 46 with an integrated mixing device 44 which is shown in FIG. 10 to 12.

Concerning the three solutions according to the invention which are described by way of example, a regulation of the temperature has been described by way of adjusting the mixing ratio solely by way of speed change. However, it is to be understood that such a feed temperature regulation could also be realized in combination with an additional valve Rₕₒₜ in the feed conduit 18 and/or a valve R_{cold} in the return conduit 16. Here, the valves Rₕₒₜ and R_{cold} can possibly be coupled to one another or be commonly formed as a three-way valve. An electrical drive of these valves could be activated by a common control device 34 which also controls or regulates the speed of the drive motor 30. The mixing ratio and thereby the temperature in the feed conduit for the floor heating can therefore be regulated or controlled by way of the control of the valves together with the control of the speed of the drive motor 30. On the one hand a greater range of regulation can be achieved by way of this, and on the other hand losses can be reduced by way of larger valve opening degrees. Hence for example the speed only needs to be briefly increased, in order to admix an increased quantity of heated heat transfer medium.

The invention was described by way of the example of a heating facility. However, it is to be understood that the invention can also be applied in a corresponding manner in other applications, in which two fluid flows are to be mixed. One possible application for example is a system for adjusting the service water temperature as is common in booster pumps for service water supply, in so-called shower booster pumps.

While specific embodiments of the invention have been shown and described in detail to illustrate the application of the principles of the invention, it will be understood that the invention may be embodied otherwise without departing from such principles.

1. A method for the operation of a mixing device in a heating facility, the method comprising the steps of:
mixing, in the mixing device, two heating medium flows of different temperatures for adjusting a temperature of the heating medium; providing the mixing device such that the mixing device comprises at least one circulation pump assembly which delivers the heating medium; and
regulating a speed of the at least one circulation pump assembly in dependence on a temperature value which is detected in the heating medium.

2. A method according to claim 1, wherein the speed of the at least one circulation pump assembly is regulated such that the detected temperature value corresponds to a predefined temperature setpoint or approximates the predefined temperature setpoint, wherein the predefined temperature setpoint is specified depending on a room temperature and/or an outer temperature.

3. A method according to claim 1, wherein the two heating medium flows are mixed at a mixing point and the temperature value is detected in the heating medium downstream of the mixing point.

4. A method according to claim 1, wherein the at least one circulation pump assembly effects at least one of the two heating medium flows, wherein the at least one circulation pump assembly delivers the heating medium downstream of a mixing point of the two heating medium flows.

5. A method according to claim 1, wherein the at least one circulation pump assembly which is regulated in its speed (n) in dependence on a temperature value which is detected in the heating medium forms a first circulation pump assembly and that a second circulation pump assembly which effects one of the heating medium flows is provided.

6. A method according to claim 5, wherein a speed of the second circulation pump assembly is regulated in dependence on a pressure and/or a flow rate of the heating medium or in dependence on a temperature value which is detected in the heating medium.

7. A method according to claim 5, wherein the first centrifugal pump assembly is situated in a first heating medium flow and is regulated in its speed in dependence on a temperature value which is detected in the heating medium, whereas the second circulation pump assembly which is preferably situated in the second heating medium flow has no speed regulation for setting the temperature of the heating medium.

8. A method according to claim 1, wherein a presetting is carried out before carrying out a speed regulation of the circulation pump assembly in dependence on a temperature value which is detected in the heating medium, the presetting comprising the steps of:
setting the circulation pump assembly to a necessary differential pressure;
presetting the two heating medium flows for reaching a currently desired temperature of the heating medium.

9. A mixing device for use in a heating facility for mixing two heating medium flows, the heating device comprising:
at least one circulation pump assembly which delivers heating medium and which is adjustable in speed;
at least one a temperature sensor which is configured and arranged to detect a temperature value of the heating medium, wherein the circulation pump assembly comprises a control device which is configured to adjust a circulation pump assembly speed in dependence on a temperature value which is detected by the temperature sensor.

10. A mixing device according to claim 9, wherein the temperature sensor is arranged at a flow path downstream of a mixing point, at which the two heating medium flows are mixed.

11. A mixing device according to claim 9, wherein a mixing point, at which the two heating medium flows are mixed is present, and the at least one circulation pump assembly is arranged in a flow path downstream of the mixing point.

12. A mixing device according to claim 8, wherein the at least one circulation pump assembly which is regulated in speed in dependence on the temperature value which is detected in the heating medium forms a first circulation pump assembly and further comprising a second circulation pump assembly situated in one of the heating medium flows.

13. A mixing device according to claim 11, wherein the second circulation pump assembly comprises a control device which is independent of the first circulation pump assembly and which is configured to adjust a speed of the second circulation pump assembly in dependence on a pressure and/or flow rate of the heating medium.

14. A mixing device according to claim 12, wherein the first and the second circulation pump assembly comprise a common control device and/or two control devices which communicate with one another and which are configured such that the first and the second circulation pump assembly are regulated in speeds in dependence on the temperature value which is detected by the temperature sensor.

15. A mixing device according to claim 11, wherein first or the second circulation pump assembly is arranged such that it additionally supplies a further heating circuit with heating medium.

16. A mixing device according to claim 8, wherein the mixing device comprises two inlets for both heating medium flows, wherein an adjusting valve for adjusting the flow through the respective inlet is arranged at at least one of the two inlets and preferably at both inlets.
